(19) United States
(12) Patent Application Publication
(10) Pub. No.: US 2026/0185669 A1
(43) Pub. Date: Jul. 2, 2026

(54) RECESSED LIGHTING SYSTEM WITH HEAT CONDUCTING CASTING

(71) Applicant: DMF, Inc., Carson, CA (US)

(72) Inventor: Michael D. Danesh, Carson, CA (US)

(73) Assignee: DMF, Inc., Carson, CA (US)

(21) Appl. No.: 19/551,834

(22) Filed: Feb. 27, 2026

Related U.S. Application Data
(63) Continuation of application No. 18/678,652, filed on May 30, 2024, now abandoned.
Application No. 18/678,652 is a continuation of application No. 17/826,847, filed on May 27, 2022, now Pat. No. 12,000,562.
Application No. 17/826,847 is a continuation of application No. 17/395,522, filed on Aug. 6, 2021, now abandoned.
Application No. 17/395,522 is a continuation of application No. 17/080,080, filed on Oct. 26, 2020, now Pat. No. 11,085,597.
Application No. 17/080,080 is a continuation of application No. 16/522,275, filed on Jul. 25, 2019, now Pat. No. 10,816,148.
Application No. 16/522,275 is a continuation of application No. 15/947,065, filed on Apr. 6, 2018, now Pat. No. 10,408,395.
Application No. 15/947,065 is a continuation of application No. 14/184,601, filed on Feb. 19, 2014, now Pat. No. 9,964,266.
(60) Provisional application No. 61/843,278, filed on Jul. 5, 2013.

(51) Int. Cl. F21S 8/02; F21V 7/04; F21V 23/00; F21Y 115/10; H04R 1/24; H04R 17/00; H04R 23/02

(52) U.S. Cl. CPC F21S 8/02; F21S 8/026; F21V 7/041; F21V 23/006; H04R 17/00; H04R 23/02; F21Y 2115/10; H04R 1/24; H04R 2499/11

(57) ABSTRACT

A recessed lighting system includes a substantially heat conducting unified casting having a front face and a rear heat conducting portion and having dimensions to fit inside a standard-sized junction box. The system further includes a light source module, housed within the heat conducting unified casting, to emit light, wherein the light source module is positioned closer to the rear heat conducting portion than the front face of the substantially heat conducting unified casting. A driver, housed within the heat conducting unified casting and insulated from the heat conducting unified casting, provides power the light source module. A lens, coupled to the heat conducting unified casting, direct lights produced by the light source module out into an area surrounding the recessed lighting system. The substantially heat conducting unified casting significantly dissipates heat generated by the light source module during operation of the light source module.

### CROSS-REFERENCE TO RELATED APPLICATION

This application is a continuation (CON) of U.S. application Ser. No. 18/678,652, filed May 30, 2024, which is a continuation (CON) of Ser. No. 17/826,847, filed May 27, 2022, which is a continuation (CON) application of U.S. application Ser. No. 17/395,522, filed Aug. 6, 2021, which is a continuation (CON) application of U.S. application Ser. No. 17/080,080, filed Oct. 26, 2020, which is a continuation (CON) application of U.S. application Ser. No. 16/522,275, filed Jul. 25, 2019, which is a continuation (CON) of U.S. application Ser. No. 15/947,065, filed Apr. 6, 2018, which is a continuation (CON) application of U.S. application Ser. No. 14/184,601, filed Feb. 19, 2014, which claims the benefit of the earlier filing date of U.S. provisional application no. 61/843,278, filed Jul. 5, 2013. Each of the above-identified applications is incorporated herein by reference in its entirety.

### FIELD

An embodiment relates to a compact recessed lighting system that includes a light source module and a driver in a single unified casting, which along with an optical light reflector shields the driver from exposure to outside elements and allows the recessed lighting system to be installed in a standard junction box. In some embodiments, this compact recessed lighting system may be utilized in 4-10″ recessed new construction and remodel products and in retrofit applications. Moreover, in some embodiments, this compact recessed lighting system may be utilized with interchangeable trims to accommodate different aperture luminaires. Other embodiments are also described.

### BACKGROUND

Recessed lighting systems are typically installed or mounted into an opening in a ceiling or a wall. Recessed lighting systems generally consist of a trim, a light source module, a driver, and a “can” housing. The driver is insulated from other portions and components of the recessed lighting system, including the light source module, through the use of a separate insulating container. The driver may be electrically coupled to the light source module through the use of wires or other conduits such that the driver may power the light source module to emit light.

The separation between the driver and the light source module adds to the combined size of the recessed lighting system. In particular, the use of a separate container that houses the driver separate from the other portions and components of the recessed lighting system, including the light source module, increases the size of the recessed lighting system. This increased size restricts the recessed lighting system to be placed in constrained spaces within a ceiling or a wall and may increase the overall cost of the recessed lighting system.

### BRIEF DESCRIPTION OF THE DRAWINGS

The embodiments of the invention are illustrated by way of example and not by way of limitation in the figures of the accompanying drawings in which like references indicate similar elements. It should be noted that references to “an” or “one” embodiment of the invention in this disclosure are not necessarily to the same embodiment, and they mean at least one.

FIG. 1 shows an exploded view of a recessed lighting system according to one embodiment.

FIG. 2 shows top and side views of a junction box according to one embodiment.

FIG. 3 shows a side view of the recessed lighting system according to one embodiment.

### DETAILED DESCRIPTION

Several embodiments are described with reference to the appended drawings are now explained. While numerous details are set forth, it is understood that some embodiments of the invention may be practiced without these details. In other instances, well-known circuits, structures, and techniques have not been shown in detail so as not to obscure the understanding of this description.

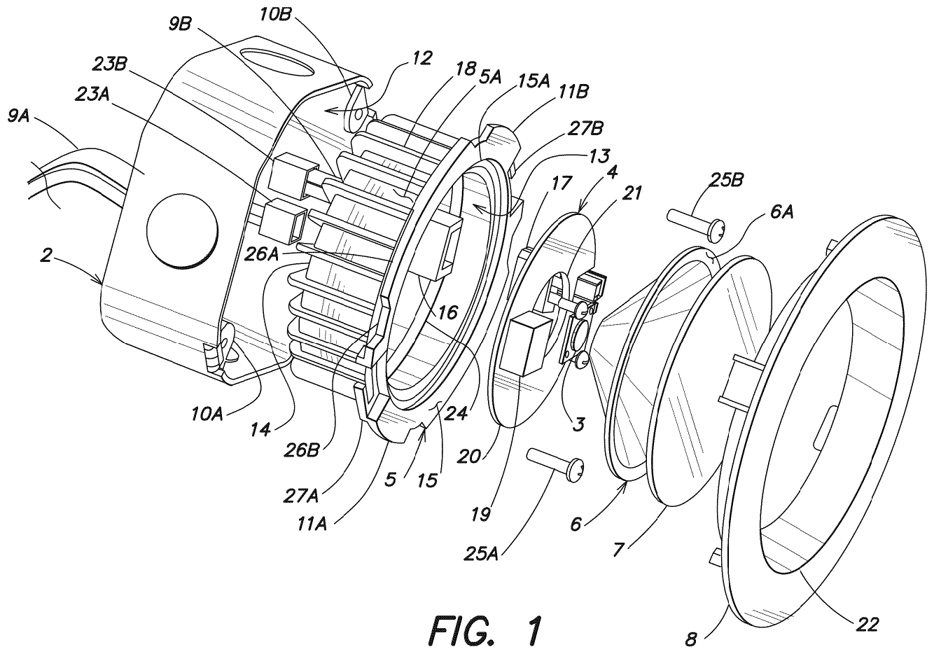

FIG. 1 shows an exploded view of a recessed lighting system 1. The recessed lighting system 1 may include a junction box 2, a light source module 3, a driver (e.g., a power supply) 4, a unified casting 5, a reflector 6, a lens 7, and a trim 8. As will be described in further detail below, the recessed lighting system 1 provides a more compact and cost effective design while complying with all building and safety codes/regulations. Although shown with a single junction box 2 and trim 8, the light source module 3, the driver 4, the unified casting 5, the reflector 6, and the lens 7 may be similarly used with different sized junction boxes 2 and trims 8. Each of the elements of the recessed lighting system 1 will be explained by way of example below.

The junction box 2 is a structure that separates the inner components of the recessed lighting system 1, including electrical wires/cables, from the items inside a ceiling or crawl space (e.g., insulation) in which the junction box 2 has been installed. In one embodiment, the junction box 2 is directly coupled to a stud, beam, or other structural member inside the ceiling or crawl space through the use of resins, clips, screws, bolts, clamps, or any other type of connecting mechanism. The junction box 2 may be equipped with one or more bar-hangers to assist installation when the junction box 2 needs to be located between two studs or joists. In one embodiment, the junction box 2 may be a single or double gang box with a fire rating of up to two hours as described in the National Electrical Code (NEC) and by the Underwriters Laboratories (UL). The junction box 2 may receive electrical wires 9A from an electrical system (e.g., 120 VAC or 277 VAC) within a building or structure in which the recessed lighting system 1 is installed. The electrical wires 9A from the structure may be connected to corresponding wires 9B of the unified casting 5, as will be described in greater detail below.

In one embodiment, the junction box 2 may include one or more tabs 10A, 10B for coupling the junction box 2 to the casting 5. The tabs 10A, 10B may be any device/component for receiving corresponding elements 27A, 27B of the casting 5 to firmly hold the weight of the unified casting 5, the light source module 3, the driver 4, the reflector 6, the lens 7, and/or the trim 8 up against the junction box 2. As shown in FIG. 1, the tabs 10A, 10B include holes for receiving screws or bolts 25A, 25B through the corresponding elements 27A, 27B; however, in other embodiments the tabs 10A, 10B may facilitate a twist-and-lock friction connection with corresponding elements 27A, 27B of the casting 5 and without the use of separate tools or other devices. In still other embodiments, friction or tension clips may be utilized to couple the casting 5 to the junction box 2.

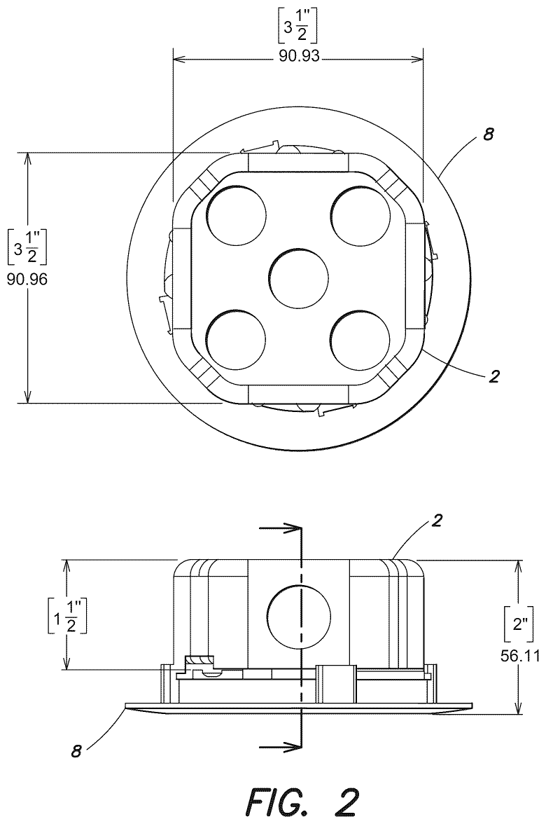

In one embodiment, the junction box 2 acts as a heat barrier to block heat emitted by the light source module 3 and the driver 4 from reaching possibly flammable items inside a ceiling or crawl space. In these embodiments, the junction box 2 may be formed of metals, polymers, metal alloys, and/or other heat insulating materials. As shown in FIG. 1, the junction box 2 may be a polygon that defines a cavity 12 therein. However, in other embodiments, the junction box 2 may be any suitable shape, including an ellipsoid, cone, or cylinder that is capable of receiving therein the casting 5. The cavity 12 that is formed in the junction box 2 may be larger than the casting 5 such that the casting 5 may easily fit into the cavity 12 without coming into direct contact with the walls of the cavity 12. However, in other embodiments, the casting 5 may be sized to come into direct contact with the walls of the cavity 12. The size of the cavity 12 may be pursuant to popular industry specifications for junction boxes and in compliance with all applicable building and safety codes/regulations. For example, as shown in FIG. 2, the junction box 2 may have a length of 3½ inches, a width of 3½ inches and a depth of 1½ inches. When coupled together, the combined junction box 2, light source module 3, driver 4, casting 5, reflector 6, lens 7, and trim 8 may have a height/depth of 2 inches.

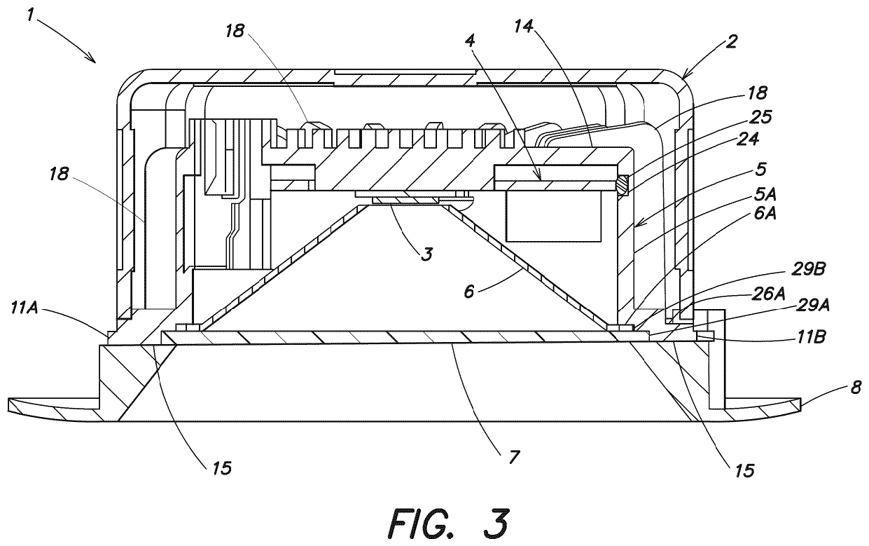

The junction box 2 is a shell and/or enclosure that further prevents the exposure of heat from the light source module 3 and the driver 4 to the items inside a ceiling or crawl space (e.g., insulation) in which the recessed lighting system 1 has been installed. The casting 5 may be formed of metals, polymers, metal alloys, and/or other materials. As shown in FIG. 1, the casting 5 may be a cylindrical structure that defines a casting cavity 13 therein. However, in other embodiments, the casting 5 may be any suitable shape, including an ellipsoid, cone, or polygon that is capable of housing the light source module 3 and the driver 4. As shown in FIGS. 1 and 3, the cavity 13 is to receive therein the light source module 3 and the driver 4.

In one embodiment, the casting 5 may include a closed rear face 14 and an open front face 15a. The closed rear face 14 allows the light source module 3 and the driver 4 to be securely mounted to the casting 5, while the open front face 15a provides an aperture to allow light emitted by the light source module 3 to be exposed to an outside environment surrounding the recessed lighting system 1 (e.g., into a room). In one embodiment, the rear face 14 of the casting 5 may include one or more mounting elements for receiving and securely holding the light source module 3 and the driver 4. In some embodiments, the mounting elements may be holes, flaps, or other structures designed to receive the light source module 3 and the driver 4. The mounting elements may be capable of receiving resins, clips, screws, bolts, clamps, or any other type of connecting mechanism such that the light source module 3 and the driver 4 may be securely coupled inside the cavity 13 on the rear face 14 of the casting 5. In one embodiment, the light source module 3 and the driver 4 are removably coupled to the casting 5 while in other embodiments one or more of the light source module 3 and the driver 4 form a single continuous and indivisible component with the casting 5.

Although described as a casting 5, the casting 5 may be formed through other processes other than casting techniques. For example, the casting 5 may be formed through an extrusion process or formed through the welding of metal sheets to form a structure. Further, although described as an enclosed assembly, the casting 5 may be any heat conducting structure to which the light source module 3 and the driver 4 are mounted and which can be mounted, using any type of fasteners or mounting elements, to the junction box 2.

In one embodiment, the electrical wires 9A received by the junction box 2 from the electrical system of a building or structure may be coupled to the electrical wires 9B of the casting 5. The electrical wires 9A may be coupled to the electrical wires 9B through the use of electrical caps or other devices. For example, as shown in FIG. 1, the electrical wires 9A and 9B may be connected using the connectors 23A and 23B. The connectors 23A and 23B are complimentary, keyed or interlocking connectors. The electrical wires 9B of the casting 2 may terminate in a connector holder 16 that may receive a corresponding connector 17 of the driver 4. In one embodiment, the connectors 16 and 17 are complimentary, keyed or interlocking connectors similar to the connectors 23A and 23B described above. When the connectors 16 and 17 are engaged, electricity may pass from the electrical system of the building or structure to the driver 4.

In one embodiment, the casting 5 includes one or more heat sinks 18 to dissipate heat generated by the light source module 3 and/or the driver 4. Although the heat sinks 18 are shown as passive components that cool the combined casting 5, light source module 3, and driver 4 by dissipating heat into the surrounding air, active heat sinks (e.g., fans) may also be used. In one embodiment, the heat sinks 18 are defined by a set of fins surrounding the casting 5. The heat sinks 18 may be composed of any thermally conductive material. For example, the heat sinks 18 may be made of aluminium alloys, copper, copper-tungsten pseudoalloy, A1SiC (silicon carbide in aluminium matrix), Dymalloy (diamond in copper-silver alloy matrix), E-Material (beryllium oxide in beryllium matrix), and/or thermally conductive plastics or ceramics.

As described above, the recessed lighting system 1 may include the driver 4. The driver 4 is an electronic device that supplies and/or regulates electrical energy to the light source module 3 and thus powers the light source module 3 to emit light. The driver 4 may be any type of power supply, including power supplies that deliver an alternating current (AC) or a direct current (DC) voltage to the light source module 3. In one embodiment, the driver 4 receives electricity from the casting 5 via a connector. In one embodiment, the connector 17 is coupled to the connector holder 16 of the casting 5 such that electrical wires are not protruding from the casting 5. In this embodiment, the supply connection from the driver 4 terminates in connector 17, which is force-fitted into connector holder 16. In another embodiment, the driver 4 may connect to the supply wires, 9A, via wire nuts.

Upon receiving electricity, the driver 4 may regulate current or voltage to supply a stable voltage or current within the operating parameters of the light source module 3. The driver 4 receives an input current from the electrical system of the building or structure in which the recessed lighting system 1 is installed and drops the voltage of the input current to an acceptable level for the light source module 3 (e.g., from 120V-240V to 36V-48V). The driver 4 may transfer electricity to the light source module 3 through an electrical connector. For example, the driver 4 may deliver electricity to the light source module 3 through an electrical cable coupled between the light source module 3 and the driver 4 through removable or permanent connectors or soldered leads originating from the driver 4. Although shown with magnetic transformer 19, the driver 4 may include additional circuitry for regulating current to the light source module 3.

As shown in FIG. 1, the driver 4 may also include the board 20 for holding the magnetic transformer 19 and other circuitry. In one embodiment, the board 20 is formed in a “donut”, torus, or “C” shape with an opening 21. The outside edge of the board 20 is coupled to the casting 5, while the opening 21 formed by the board 20 allows the light source module 3 to be directly coupled to the casting 5 without coming into direct contact with the driver 4. By forming a structure with the opening 21, the driver 4 allows the light source module 3 to avoid the driver 4, eliminating shadows or interference from the driver 4, and allows the light source module 3 to directly contact the casting 5, assisting the casting 5 to dissipate heat generated by the light source module 3. This compact structure allows the light source module 3 and the driver 4 to be contained within the unified casting 5, which in turn may fit inside a standard junction box (i.e., junction box 2) and/or a 4-8 inch recessed lighting fixture (both incandescent and non-incandescent). Accordingly, the recessed lighting system 1 can operate without the use of a “can” housing structure. This simplified and more compact structure reduces the cost and complexity of installing the recessed lighting structure 1 into an existing/pre-installed junction box or a newly installed junction box. Further, this configuration allows the recessed lighting system 1 to achieve a UL fire-rating of at least two hours.

In one embodiment, the board 20 may be a printed circuit board. The driver 4 may be coupled to the casting 5 using any connecting mechanism, including resins, clips, screws, bolts, or clamps. For example, in one embodiment, the driver 4 may be coupled to the casting 5 using friction or tension clips.

The light source module 3 may be any electro-optical device or combination of devices for emitting light. For example, the light source module 3 may have as a single light source a light emitting diode (LED), organic light-emitting diode (OLED), or polymer light-emitting diode (PLED). In some embodiments, the light source module 3 may have multiple light sources (e.g., LEDs, OLEDs, and/or PLEDs). The light source module 3 receives electricity from the driver 4, as described above, such that the light source module 3 may emit a controlled beam of light into a room or surrounding area. The driver 4 is designed to ensure that the approximate voltage and current are fed to the light source module 3 to enable the emission of light by the one or more light sources within the light source module 3.

As described above and shown in FIG. 1, the light source module 3 is coupled to the casting 5 in the opening 21 formed by the board 20. As described above, by positioning the light source module 3 in the opening 21, the light source module 3 may avoid the driver 4, thus eliminating shadows or interference from the driver 4, and allowing the light source module 3 to directly contact the casting 5, such that the casting 5 can dissipate heat generated by the light source module 3. Further, this compact design allows the recessed lighting system 1 to utilize a standard sized junction box (e.g., junction box 2) instead of a “can” housing structure. As shown in FIG. 1, the light source module 3 is coupled to the casting 5 using screws; however, in other embodiments, the light source module 3 may be coupled to the casting 5 using any connecting mechanism, including resins, clips, screws, bolts, or clamps. For example, in one embodiment, the light source module 3 may be coupled to the casting 5 using friction or tension clips.

In one embodiment, the casting 5 may include an insulating gasket 25 that separates the board 20 and the casting 5. The insulating gasket 25 may be placed on a groove 24 that encircles the casting cavity 13 of the casting 5. The insulating gasket 25 may be formed of materials that provide some degree of malleability and/or flexibility such that the gasket 25 is able to deform and tightly fit within the groove 24, including any slight irregularities. For example, the insulating gasket 25 may be formed of plastic, rubber, metal, and/or ceramic materials. The insulating gasket 25 assists in insulating the driver 4 from the outside environment.

In some embodiments, the recessed lighting system 1 may include the reflector 6. The reflector 6 may surround the light source module 3 and/or a light source of the light source module 3 to adjust the way light emitted by the light source module 3 is focused inside a room or surrounding area. In one embodiment, the reflector 6 surrounds the light source module 3 and separates the light source module 3 from the driver 4. This separation allows light from the light source module 3 to be emitted into a room or surrounding area while further shielding the driver 4 from being exposed to the room or surrounding area. For example, in one embodiment, the reflector 6 and the casting 5 may be coupled together such that the combined assembly may create a sealed structure to shield the driver 4 from the outside environment and the light source module 3. By shielding the driver 4 from the outside environment, the reflector 6 reduces the risk of fire or other dangers and ensures the recessed lighting system 1 complies with building and safety codes/regulations. The reflector 6 may be formed of any fire retardant material, including steel, aluminum, metal alloys, calcium silicate, and other similar materials.

In one embodiment, the reflector 6 may be coupled to the casting 5 using screws, rivets or other fasteners. The reflector 6 may also be designed as a snap fit into the casting 5.

Although shown as conical, the reflector 6 may be formed in any shape that may direct and/or focus light. For example, the reflector 6 may be parabolic, spherical, or a frusto-conical shape that is positioned over the light source module 3 while shielding the driver 4. In one embodiment, the reflector 6 may be coated with a reflecting material or include one or more reflecting elements that assist in the adjustment of light emitted by the light source module 3. For example, the reflector 6 may be coated with a shiny enamel or include one or more mirrors or retroreflectors or a microcellular polyethylene terephthalate (MCPET) material to adjust the focus of light emitted by the light module 3. In other embodiments, the reflector 6 may include various other optic elements to assist in the focusing of light emitted by the light source module 3.

In one embodiment, the recessed lighting system 1 may include a lens 7. The lens 7 may be formed to converge or diverge light emitted by the light source module 3. The lens 7 may be a simple lens comprised of a single optical element or a compound lens comprised of an array of simple lenses (elements) with a common axis. In one embodiment, the lens 7 also provides a protective barrier for the light source module 3 and shields the light source module 3 from moisture or inclement weather. The lens 7 may also assist in the diffusion of light and increase the uniformity of light over the surface of the recessed lighting system 1. The lens 7 may be made of any at least partially transparent material, including glass and hard plastics. In one embodiment, the lens 7 and the reflector 6 are contained in a single indivisible unit to work in conjunction to focus and adjust light emitted by the light source module 3. In other embodiments, the lens 7 and the reflector 6 are separate, divisible elements as shown in FIG. 1.

In one embodiment, the recessed lighting system 1 may include a trim 8. The trim 8 serves the primary purpose of covering the exposed edge of the ceiling or wall where a hole is formed in which the recessed lighting system 1 resides while still allowing light from the light source module 3 to be emitted into a room through an aperture 22. In doing so, the trim 8 helps the recessed lighting system 1 appear seamlessly integrated into the ceiling or wall. In one embodiment, the trim 8 is capable of coupling to the casting 5 while in other embodiments the trim 8 is capable of coupling to the junction box 2. The trim 8 may couple to the casting 5 and/or the junction box 2 using any connecting mechanism, including resins, clips, screws, bolts, or clamps. In one embodiment, the trim 8 may include grooves and/or slots to couple to corresponding grooves 26A and/or slots 26B of the casting 5 and/or the junction box 2 using a twist-and-lock friction connection and without the use of separate tools or other devices.

In one embodiment, different diameter trims 8 may be capable of being coupled to the casting 5 and/or the junction box 2. The size and design of the trims 8 may depend on the size of the hole in which the recessed lighting system 1 has been fitted and that the trim 8 must conceal, as well as the aesthetic decisions of the consumer. The trims 8 may be made of aluminum plastic polymers, alloys, copper, copper-tungsten pseudoalloy, A1SiC (silicon carbide in aluminum matrix), Dymalloy (diamond in copper-silver alloy matrix), and E-Material (beryllium oxide in beryllium matrix).

As seen in FIG. 1 the casting or housing 5 also includes a side wall 5a which in the figure is seen to be generally cylindrical and terminates in a front end face 15 which encompasses a front aperture 15a. The side wall 5a is continuous with the rear wall 14 and with heat sink fins 18 formed integrally with the side and rear walls of the unitary casting.

As shown in FIG. 1 and in FIG. 2, a trim 8 is assembled and retained to housing 5 by interlocking with twist-and-lock flanges 11A, 11B formed integrally with housing 5. The two twist and lock flanges 11A, 11B are better seen in FIG. 1 to extend radially from diametrically opposite sides of the front end face 15 integrally with side wall 5a of housing 5, and the forward surfaces of the locking flanges 11A, 11B are seen to be flush with the front end face 15.

As best seen in FIG. 3 flanges 11A, 11B also are substantially coplanar with the lens 7 as well as coplanar with a first circular rabbet recess 29A defined along an inner edge of front end face 15 and containing the lens 7. Consequently, with the lens installed in the rabbet, the front or exterior surface of lens 7 and forward surfaces of the flanges 11A, 11B define a nearly planar front surface for the compact light.

The unitary structure of the housing 5 and the coplanar location of the trim interlocking flanges 11A, 11B allow a reduction in total height of the compact light as measured between lens 7 and rear wall 14. Such reduced height in turn facilitates installation of the light in a standard but relatively small junction box which already has received a sufficient fire rating, so that the compact light can be installed in a ceiling directly in a j-box without use of a “can”, as has been explained previously herein, thus greatly simplifying installation of the compact light.

The rabbet may be a two step rabbet, as seen in FIGS. 1 and 3, such that the lens 7 is held in the larger diameter outer rabbet 29A and a rim 6a of reflector 6 is held in the smaller diameter inner rabbet 29B.

1. A recessed lighting system, comprising:
a substantially heat conducting unified casting having a front face and a rear heat conducting portion and having dimensions to fit inside a standard-sized junction box, the substantially heat conducting unified casting including a plurality of elements positioned on the casting so as to align with corresponding tabs of the standard-sized junction box;
a light source module, housed within the heat conducting unified casting, to emit light, wherein the light source module is positioned closer to the rear heat conducting portion than the front face of the substantially heat conducting unified casting;
a driver, housed within the heat conducting unified casting and insulated from the heat conducting unified casting, to power the light source module; and
a lens, coupled to the heat conducting unified casting, to direct light produced by the light source module out into an area surrounding the recessed lighting system,
wherein the substantially heat conducting unified casting significantly dissipates heat generated by the light source module during operation of the light source module.

2. The recessed lighting system of claim 1, wherein:
the rear heat conducting portion comprises one or more mounting elements; and
the driver is securely coupled to the rear heat conducting portion via the one or more mounting elements.

3. The recessed lighting system of claim 2, wherein the one or more mounting elements receive at least one of resin, a clip, a screw, a bolt, or a clamp.

4. The recessed lighting system of claim 2, further comprising:
a plurality of electrical wires coupled to the driver and passing through the rear heat conducting portion of the heat conducting unified casting.

5. The recessed lighting system of claim 1, further comprising:
a reflector positioned within the heat conducting unified casting between the light source module and the lens.

6. The recessed lighting system of claim 1, wherein the front face of the heat conducting unified casting comprises a twist-and-lock mechanism to facilitate coupling with a trim, the twist-and-lock mechanism comprising at least one of multiple slots or multiple flanges that extend radially outward.

7. The recessed lighting system of claim 1, wherein the heat conducting unified casting has an outside width less than 3½ inches.

8. The recessed lighting system of claim 1, wherein the recessed lighting system has a depth dimension less than 1½ inches.

9. The recessed lighting system of claim 1, further comprising the standard-sized junction box to contain the heat conducting unified casting.

10. A recessed lighting system, comprising:
a lighting assembly, comprising:
a substantially heat conducting unified casting having an outside width less than 3½ inches and configured to fit between multiple tabs of a standard-sized junction box, the casting comprising a plurality of heat sink fins and a front end face, the front end face comprising a tool-less mating mechanism to facilitate coupling with a trim;
a light source module, housed within the heat conducting unified casting, including at least one LED to emit light; and
an AC to DC converter to receive an AC voltage and supply regulated electrical energy to power the light source module.

11. The recessed lighting system of claim 10, wherein the AC to DC converter includes a circuit board housed within the heat conducting unified casting.

12. The recessed lighting system of claim 10, wherein:
the tool-less mating mechanism comprises a twist-and-lock mechanism; and
the twist-and-lock mechanism comprises at least one of multiple slots or multiple flanges that extend radially outward.

13. The recessed lighting system of claim 10, wherein the front end face further comprises holes configured for alignment with the multiple tabs of the standard-sized junction box.

14. The recessed lighting system of claim 10, wherein the AC to DC converter is insulated from the heat conducting unified casting.

15. The recessed lighting system of claim 10, wherein:
the heat conducting unified casting further comprises a closed rear face, the closed rear face comprising one or more mounting elements; and
the AC to DC converter is securely coupled to the closed rear face via the one or more mounting elements.

16. The recessed lighting system of claim 15, wherein the one or more mounting elements receive at least one of resin, a clip, a screw, a bolt, or a clamp.

17. The recessed lighting system of claim 10, further comprising:
a plurality of electrical wires coupled to the AC to DC converter and passing through the closed rear wall of the heat conducting unified casting.

18. The recessed lighting system of claim 10, further comprising:
the trim coupled to the front end face of the lighting assembly via the tool-less mating mechanism.

19. The recessed lighting system of claim 10, further comprising:
the standard-sized junction box,
wherein the lighting assembly is contained within the standard junction box.

20. A recessed lighting system, comprising:
a lighting assembly, comprising:
a substantially heat conducting unified casting comprising a front end face, a closed rear face, and a plurality of heat sink fins, the front end face comprising a twist-and-lock mechanism to facilitate coupling with a trim, the twist-and-lock mechanism comprising at least one of multiple slots or multiple flanges that extend radially outward, the closed rear face comprising one or more mounting elements, the heat conducting unified casting having an outside width less than 3½ inches;
a light source module, housed within the heat conducting unified casting and positioned closer to the closed rear face than the front end face, including at least one LED to emit light;
an AC to DC converter, housed within the heat conducting unified casting, to receive an AC voltage and supply regulated electrical energy to power the light source module, the AC to DC converter being insulated from the heat conducting unified casting, the AC to DC converter being securely coupled to the closed rear face via the one or more mounting elements; and
a plurality of electrical wires coupled to the AC to DC converter and passing through the closed rear face of the heat conducting unified casting.
